(19) United States
(12) Patent Application Publication
(10) Pub. No.: US 2025/0080911 A1
(43) Pub. Date: Mar. 6, 2025

(54) Method and System for Selective Audio Playback on A Loudspeaker and A Headset

(71) Applicant: Apple Inc., Cupertino, CA (US)

(72) Inventors: Symeon Delikaris Manias, Los Angeles, CA (US); Afrooz Family, San Francisco, CA (US); Shai Messingher Lang, Santa Clara, CA (US); Ronald J. Guglielmone, JR., Redwood City, CA (US)

(21) Appl. No.: 18/803,081

(22) Filed: Aug. 13, 2024

Related U.S. Application Data
(60) Provisional application No. 63/580,337, filed on Sep. 1, 2023.

(51) Int. Cl. H04R 5/033; H04R 3/12

(52) U.S. Cl. CPC H04R 5/033; H04R 3/12; H04R 2400/01; H04R 2420/07; H04S 2400/01

(57) ABSTRACT

A method that includes driving a first speaker of a first electronic device using a mix of a first audio signal and a second audio signal. The method determines that the first electronic device is within a threshold distance of a second electronic device within an environment in which the first electronic device is located, where the second electronic device includes a second speaker. Responsive to determining that the first electronic device is within the threshold distance, causing the second electronic device to playback the second audio signal through the speaker and driving the first speaker using the first audio signal instead of the mix.

### RELATED APPLICATION

This application claims the benefit of priority of U.S. Provisional Patent Application No. 63/580,337 filed Sep. 1, 2023, which is herein incorporated by reference.

### FIELD

An aspect of the disclosure relates to a method and system that selects (e.g., partial) audio playback on a loudspeaker device and a headset. Other aspects are also described.

### BACKGROUND

Headphones are an audio device that includes a pair of speakers, each of which is placed on top of a user's ear when the headphones are worn on or around the user's head. Similar to headphones, earphones (or in-ear headphones) are two separate audio devices, each having a speaker that is inserted into the user's ear. Both headphones and earphones are normally wired to a separate playback device, such as an MP3 player, that drives each of the speakers of the devices with an audio signal in order to produce sound (e.g., music). Headphones and earphones provide a convenient method by which the user can individually listen to audio content without having to broadcast the audio content to others who are nearby.

Spatial audio can be rendered using headphones. In particular, the headphones may reproduce a spatial audio signal to simulate a soundscape around the listener. An effective spatial sound reproduction can render sounds such that the listener perceives a sound as coming from a location within the soundscape external to the listener's head, just as the listener would experience the sound if encountered in the real world (e.g., without the use of sound reproduction by the headphones).

### SUMMARY

According to an aspect of the disclosure is a method performed by at least one programmed processor of a first electronic device, the method includes: driving a first speaker of the first electronic device using a mix of a first audio signal and a second audio signal; determining that the first electronic device is within a threshold distance of a second electronic device within an environment in which the first electronic device is located, the second electronic device comprising a second speaker; responsive to the determining that the first electronic device is within the threshold distance, causing the second electronic device to drive the second speaker with the second audio signal; and driving the first speaker using the first audio signal instead of the mix.

In one aspect, the first audio signal and the second audio signal include different portions of a piece of audio content. In another aspect, the first audio signal includes a sound of a first software application, and the second audio signal includes sound of a second software application.

In one aspect, the first electronic device determines, for each of the first and second audio signals, one or more audio characteristics; and selects the second audio signal for playback by the second electronic device based on a comparison between the one or more audio characteristics of the first and second audio signals. In another aspect, the one or more audio characteristics includes at least one of: an indication of whether a respective audio signal is of a private or a non-private nature, a spectral analysis of the respective audio signal, a type of audio content associated with the respective audio signal, and spatial characteristics of the audio content associated with the respective audio signal. In some aspects, the one or more audio characteristics of the second audio signal includes an indication that sound of the second audio signal is shared with a third electronic device that is within the environment with the first electronic device, where the second audio signal is selected based on the indication.

In one aspect, the first electronic device may be a headset. In another aspect, the first speaker is an extra-aural speaker, and the headset is an open-back headset that is arranged to allow sound from the environment to pass through the headset to be heard by a user who is wearing the open-back headset. In some aspects, the first electronic device captures, using a microphone of the headset, a microphone signal that includes one or more sounds of the environment that has sound of the second audio signal produced by the second speaker; and reproduces at least the sound of the second audio signal through the first speaker by applying an acoustic transparency function to the microphone signal.

According to another aspect of the disclosure is a first electronic device that includes: a first speaker; a processor; and memory having stored therein instructions which when executed by the processor causes the first electronic device to: receive audio content, determine that the first electronic device is within a physically audible range of a second electronic device, wherein the second electronic device comprises a second speaker, cause the second electronic device to playback a first portion of the audio content through the second speaker, and playback a second portion of the audio content through the first speaker.

In one aspect, the first portion of the audio content includes direct sound, and the second portion of the audio content includes ambient sound. In another aspect, the audio content is of an extended reality (XR) environment in which a first user of the first electronic device is participating, where the first portion of the audio content includes speech of a second user who is participating within the XR environment. In some aspects, the first electronic device includes a display, the memory has further instructions to: display a visual representation of the XR environment that includes an avatar of the second user; and responsive to determining that the first electronic device is within a physically audible range of the second electronic device, move the avatar to a virtual location within the XR environment that corresponds to a physical location of the second electronic device with respect to the first electronic device.

In some aspects, the memory has further instructions to decompose the audio content into the first portion and the second portion based on an audio characteristic of the audio content. In another aspect, the audio characteristic comprises an indication of at least one of that 1) the second portion includes speech of an audio call between the first electronic device and another electronic device and an indication that the first portion includes background sounds of the audio call, 2) the first portion includes non-private speech, and 3) the first portion includes sounds shared between the first electronic device and another electronic device. In another aspect, the first electronic device may be a head mounted device, and the first speaker may be an extra-aural speaker.

According to another aspect of the disclosure includes a processor of a headset that is configured to: playback a first sound and a second sound of audio content through a first speaker; determine that an electronic device is to playback the first sound of the audio content through a second speaker; responsive to determining that the electronic device is to playback the first sound, transmit, via a wireless connection, a control signal to the electronic device to cause the electronic device to playback the first sound of the audio content through the second speaker; cease playing back the first sound of the audio content through the first speaker; and continue to playback the second sound of the audio content through the first speaker.

In one aspect, the processor is further configured to determine that the electronic device is within a threshold distance of the headset, where a determination that the electronic device is to playback the first sound is in response to determining that the electronic device is within the threshold distance. In another aspect, the electronic device may be a first electronic device, where processor may be further configured to: determine that the headset is within the threshold distance from a second electronic device; and determine, for each of the first and second electronic devices, a device characteristic, where determining that the electronic device is to playback the first sound includes determining that the first electronic device is to playback the first sound of the audio content instead of the second electronic device based on a comparison of the device characteristics of the first and second electronic devices device. In some aspects, the device characteristics of the first and second electronic devices includes at least one of locations, sensitivities, power ratings and a playback availability of the first and second electronic devices. In another aspect, determining the device characteristic includes determining a first physical location of the first electronic device within an environment of the headset and a second physical location of the second electronic device within the environment, the first sound is associated with a virtual sound source at a virtual location within an extended reality (XR) environment, determining that the first electronic device is to playback the first sound includes determining that the virtual location within the XR environment corresponds to the first physical location of the first electronic device within the environment. In one aspect, the processor is further configured to: determine that the headset is outside the threshold distance from the electronic device; responsive to a determination that the headset is outside the threshold distance, transmit, via the wireless connection, another control signal to the electronic device to cause the electronic device to cease playback of the first sound; and begin to playback the first and second sounds of the audio content through the first speaker. In one aspect, the electronic device is a smart speaker.

According to another aspect of the disclosure is a system as shown and as described herein. According to another aspect of the disclosure is a non-transitory machine-readable medium having instructions stored therein which when executed by a processor causes the processor to perform operations as herein described.

According to another aspect of the disclosure, a system or an electronic device as shown and as described herein. According to another aspect of the disclosure, a method substantially as herein described. According to another aspect of the disclosure, a processor substantially as herein described. According to another aspect of the disclosure, a non-transitory machine-readable medium having instructions stored therein which when executed by the processor causes the processor to perform substantially as herein described.

The above summary does not include an exhaustive list of all aspects of the disclosure. It is contemplated that the disclosure includes all systems and methods that can be practiced from all suitable combinations of the various aspects summarized above, as well as those disclosed in the Detailed Description below and particularly pointed out in the claims. Such combinations may have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIGS. 1a and 1b illustrate a system performing selective audio playback on a playback device and an output device according to one aspect.

FIG. 2 shows a block diagram of the system that includes the playback device and the output device according to one aspect.

FIG. 3 is a flowchart of one aspect of a process for selective audio playback.

FIG. 4 is a flowchart of another aspect of a process for selective audio playback according to one aspect.

FIG. 5 is a flowchart of an aspect of a process for determining which of one or more devices are to playback different types of sounds for selective audio playback according to one aspect.

FIG. 6 illustrates an example of system hardware.

### DETAILED DESCRIPTION

Several aspects of the disclosure with reference to the appended drawings are now explained. Whenever the shapes, relative positions and other aspects of the parts described in a given aspect are not explicitly defined, the scope of the disclosure here is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description. Furthermore, unless the meaning is clearly to the contrary, all ranges set forth herein are deemed to be inclusive of each range's endpoints.

As referenced herein, “audio content” may be (and include) any type of (e.g., user-desired) audio, such as a musical composition, a podcast, audio of an extended reality (XR) environment (e.g., virtual reality (VR), augmented reality (AR), and/or mixed reality (MR) environment), a soundtrack of a motion picture, etc. In another aspect, audio content may include sounds of one or more software applications, such as sounds of a virtual personal assistant (VPA) application, of a navigation application providing audible instructions, and a telephony application providing sound of a telephone call. Audio content may include system sounds or audible alerts, or any type of sound for playback by an electronic device through one or more speakers. In one aspect, the audio content may be a part of a piece of audio content, which may be an audio program or audio file that includes one or more audio signals that includes at least a portion of the audio content. In some aspects, the audio program may be any type of audio content format. In one aspect, an audio program may include audio content for spatial rendering as one or more data files in one or various three-dimensional (3D) audio formats, such as having one or more audio channels. For instance, an audio program may include a mono audio channel or may include multiple audio channels in a multi-audio channel format (e.g., two stereo channels, six surround source channels (in 5.1 surround format), etc.). In another aspect, the audio program may include one or more audio objects, each having at least one audio signal, and metadata (e.g., positional data) for spatially rendering the object's audio signals in 3D sound. In another aspect, the audio program may be represented in a spherical audio format, such as higher order ambisonics (HOA) audio format.

Audio reproduction may be performed through the use of various electronic devices, such as loudspeakers (or loudspeaker devices) that may be arranged to playback sound into a listening environment or headphones that may be worn on a listener's head (or ears) and may be arranged to playback sound into or around the listener's ears. Unlike loudspeakers, headphones may provide a more individualized listening experience. Headphones, however, have some disadvantages to loudspeakers. For instance, headphones, such as wireless headphones, may have a limited power source (e.g., battery), thereby limiting the amount of acoustic energy that may be produced by the headphones. As a result, headphones may not be able to efficiently reproduce certain audio content that requires a significant amount of power for audio reproduction, such as music with a lot of bass. Loudspeaker devices, however, may be capable of handling audio content that requires a considerable amount of acoustic power since they may be able to draw more power from an alternating current (AC) mains supply. In addition, loudspeaker devices may include more powerful audio hardware, such as speaker drivers, as opposed to headphones that may have smaller, less powerful speakers. This may be the case due to the varying sizes between both devices. Headphones may be smaller than loudspeaker devices since headphones are designed to be worn by a user, whereas loudspeaker devices may be larger than headphones and may be designed to be stationary within an environment. As a result, the hardware within headphones is smaller than hardware of loudspeaker devices. Therefore, is a need for a method and system that is capable of partially handing off a portion of audio content for playback by a loudspeaker that would otherwise be played back by headphones, thereby reducing the required acoustic (or power) load by the headphones and at the same time taking advantage of the audio hardware and playback capabilities of the loudspeaker.

To overcome these deficiencies, the present disclosure provides a method and system for partially handing off audio reproduction responsibilities to a playback (e.g., loudspeaker) device by performing selective audio playback in which one or more sounds are selected to be played back by the playback device while other sounds may be (e.g., selected to be) played back by an output device, such as a headset (or another user device). In particular, the headset, which may be a wireless headset, may drive a first speaker using a mix of two or more audio signals that each include one or more sounds. The mix may include an input audio signal that includes user-desired audio content, such as a musical composition streamed through a media (music) software application, and may include a notification audio signal produced by a software application, such as a VPA application. The system may determine that a playback device, such as a smart speaker is within a threshold distance (e.g., within an audible range) of the headset, which may be due to a user of the headset moving within or into an environment that includes the playback device. In which case, the smart speaker may include higher quality (e.g., more powerful) speakers than the headset, for example, the smart speaker may be designed with larger speakers than the headset since the smart speaker may be a stationary device (e.g., a device meant to playback sound without being worn or held by a user). The system may cause the smart speaker to playback the user-desired audio content that would otherwise be played back by the headset (e.g., if not within the threshold distance), and the headset may (e.g., continue to) playback the notification audio signal instead of the mix. For example, the system may transfer audio content from the media software application to the smart speaker, or instruct the smart speaker to retrieve the audio content (e.g., from a local or remote source). As a result, the system may hand-off audio reproduction of the musical composition on the smart speaker, while the headset may continue to playback the sounds of the VPA application. Handing off the musical composition may conserve power consumption at the headset, while also allowing the system to take advantage of the smart speaker's ability to produce higher quality sound than the headset (e.g., by providing extra bass than would otherwise be provided by the headset), thereby improving the user experience.

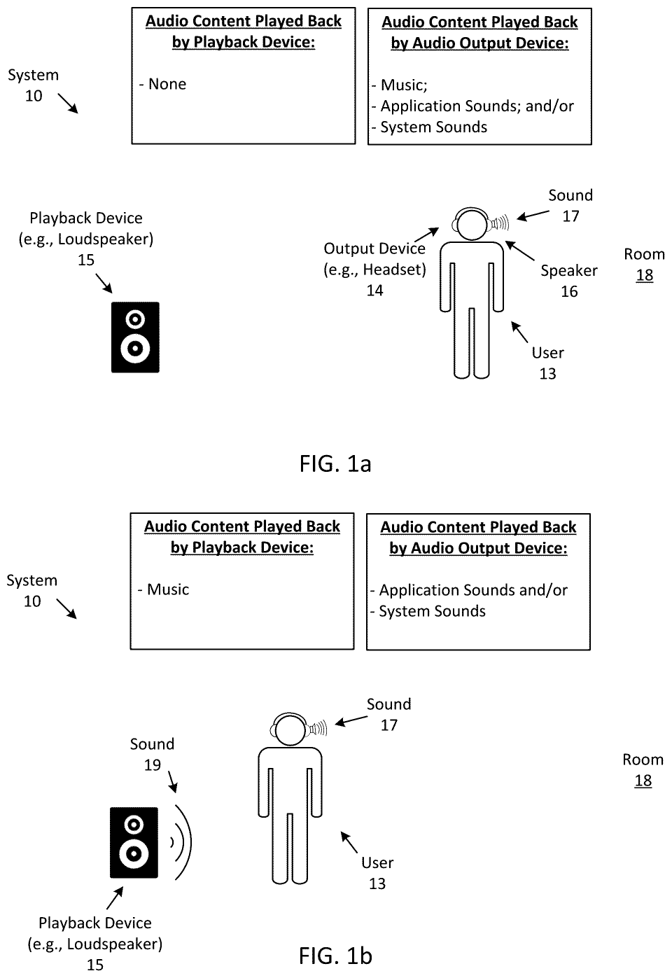

FIGS. 1a and 1b illustrate a system 10 performing selective audio playback on a playback device 15 and an output device 14 according to one aspect. Specifically, each of these figures illustrates a room 18 that includes a system 10 that has a playback device 15 and a user 13 who has (e.g., is wearing) an output device 14. In one aspect, although illustrated as being in the same room, at least one of the devices may be in a different room (or location), such as the output device 14.

As illustrated, the playback device 15 may be a loudspeaker device, such as a stand-alone loudspeaker. In another aspect, the playback device may be any type of electronic device that has one or more speakers (or speaker drivers) that may be capable of producing (or projecting) sound into an environment, such as the room 18. For example, the playback device may be a laptop computer, a desktop computer, a smart speaker, a (e.g., stand-alone) loudspeaker, etc. In one aspect, the playback device may be a part of an audio system, such as being a part of a home theater system or an infotainment system that may be integrated within a vehicle. In another aspect, the playback device may be a non-portable electronic device (e.g., a device that is designed to normally operate while resting, coupled, mounted, or attached to a surface or object, such as a television that may be mounted to a wall). In another aspect, the playback device may be a portable device, such as a tablet computer, a smartphone, etc. In another aspect, the playback device may be a wearable device (e.g., a device that is designed to be worn on (e.g., attached to clothing and/or a body of) a user, such as a smart watch.

In one aspect, the output device 14 may be any (e.g., portable) electronic device that includes at least one speaker and may be configured to output (or playback) sound by driving the speaker(s) with one or more audio signal(s). For instance, as illustrated, the output device 14 is a wireless headset (e.g., in-ear headphones or earphones) that are designed to be positioned on (or in) a user's ears and are designed to output sound into the user's ear canal. In another aspect, the headset may be any electronic device that may be mounted or worn on a user's head, such as smart glasses. As another example, the output device may be any type of headset, such as an over-the-car (or on-the-ear) headset that at least partially covers the user's cars and is arranged to direct sound into the cars of the user. In some aspects, the headset may be one or more earphones, where each carphone may be a sealing type that has a flexible car tip that serves to acoustically seal off the entrance of the user's ear canal from an ambient environment by blocking or occluding in the car canal. In another aspect, the headset may be an open-back headset that may allow air (sound) to pass through one or both car cups that are over (or on) the user's ears. In another aspect, the output device may be a wearable electronic device, such as a smart watch. In another aspect, the output device (or headset) may be a head mounted device (HMD), which may or may not include a display. In another aspect, the output device 14 may be a hearing aid device that is configured to produce amplified ambient sounds into the car (e.g., canal) of a user.

As described herein, the output device 14 may be a wireless device that may be configured to communicatively couple to one or more devices, such as the playback device 15 in order to exchange (e.g., audio) data. For instance, the output device 14 may be configured to establish the wireless connection with the playback device via a wireless communication protocol (e.g., BLUETOOTH protocol or any other wireless communication protocol). During the established wireless connection, the devices may exchange (e.g., transmit and receive) data packets (e.g., Internet Protocol (IP) packets), such as the output device 14 transmitting audio content as one or more data packets that include audio digital data in any audio format.

As shown, the output device 14 may be a head-worn device that may include a speaker 16. In one aspect, the speaker may be an “extra-aural” speaker that may be arranged to project sound into the ambient environment. In particular, the extra-aural speakers may be arranged to project sound into the environment and towards (or in the direction of) a portion of a user, such as one or more ears of the user. In which case, the output device may not cover or may partially cover one or both of the user's ears, thereby allowing the sound produced by the speaker to be heard by the user. In another aspect, the output device may be an open-back headset that includes the speaker 16, where the user may perceive the sound 17 produced by the speaker 16 that passes through the headset and into the user's ear. In one aspect, the speaker may be configured to direct sound away from the user (e.g., in a direction that is away from at least a portion, such as cars or ear canals, of a wearer). In another aspect, the speaker may be an “internal” speaker that may be arranged to project the sound 17 into (or towards) a user's ear canal when worn.

Returning to FIG. 1a, this figure shows the system 10 in which the output device 14 is playing back audio content, while the playback device is not playing back any audio content (or may be producing sound that may not be perceivable by the user). In particular, the output device 14 may be driving the speaker 16 with (e.g., a mix of) one or more input audio signals to produce sound 17 of the audio content, which may include music, software application sounds, and/or system sounds (or notifications). In this case, the speaker 16 may be an extra-aural speaker and the output device may be an open-back headset that is designed to allow at least a portion of the sound 17 to pass through the headset into the user's ears.

The playback device 15, however, is not playing back any audio content. In one aspect, the output device 14 may be assigned (or dedicated) for playing back audio content, such as the listed audio content, whereas the playback device 15 may not be assigned for playing back the (e.g., listed) audio content. For example, the output device 14 may be assigned to playback software application sounds (e.g., application notifications), such that upon the output device 14 receiving an indication that a notification is to be played back to the user from a software application, the output device 14 may playback the sound through the speaker 16.

FIG. 1b shows a partial (selective) handoff of audio content from being played (or assigned to play) back by the output device 14 to the playback device 15. In particular, this figure shows that one or more sounds have been selected for audio playback by the playback device 15. As shown, the user 13 has moved closer to the playback device 15, and the playback device 15 is now playing back sound 19 of music, while the output device 14 is playing back sound 17 that no longer includes the music but may include the application sounds and/or system sounds.

In one aspect, the system 10 may be configured to perform partial audio reproduction hand-off based on the location of the output device 14 with respect to the playback device 15. As shown in FIG. 1b, the user 13 has moved closer to the playback device 15. The system may determine that the output device 14 is within a threshold distance of the playback device 15. The threshold distance may be an acoustic audible range, where within the range the user (or a person) may be capable of hearing the sound 19 reproduced by the playback device (e.g., when played back at a certain output level), and outside the range the user may be unable to hear the sound 19 (e.g., due to the inverse square law). In response to determining that the (e.g., user 13 of the) output device 14 is within the threshold distance, the system 10 may cause the playback device 15 to playback the music, while the output device may (e.g., continue to) play back the application sounds and/or system sounds.

The system 10 may select the playback device 15 to playback the music based on various criteria. For example, upon determining that the output device 14 is within the threshold distance, the system may determine one or more device characteristics of the playback device, such as the quality of its speakers. Upon determining that the playback device is nearby and has high quality speakers (or higher quality speakers than the output device 14), the system 10 may assign the task to playback the music that may require or benefit from audio reproduction through its speakers. Whereas the other types of sounds may continue to be played back by (or assigned for audio playback by) the output device 14. This may be the case when these sounds do not require high-quality sound playback. As another example, sounds that may be of a private nature (e.g., phone calls from a doctor, or sounds that may be considered to be private, such as conversations relating to a doctor) may continue to be played back by the output device in order to avoid these sounds to be heard by others within a vicinity of the user 13. More about how the system performs partial audio reproduction handoff is described herein.

As a result, the system 10 may take advantage of the capabilities of the playback device 15, such as being able to produce extra acoustic energy as opposed to the output device 15, which may also enhance the user listening experience. In addition, by handing off some audio reproduction responsibilities, this may reduce the overall computational burden on the output device 14. Reducing the computational load on the output device may allow the device to perform other tasks and may allow the device to conserve resources, such as energy of the device's power source.

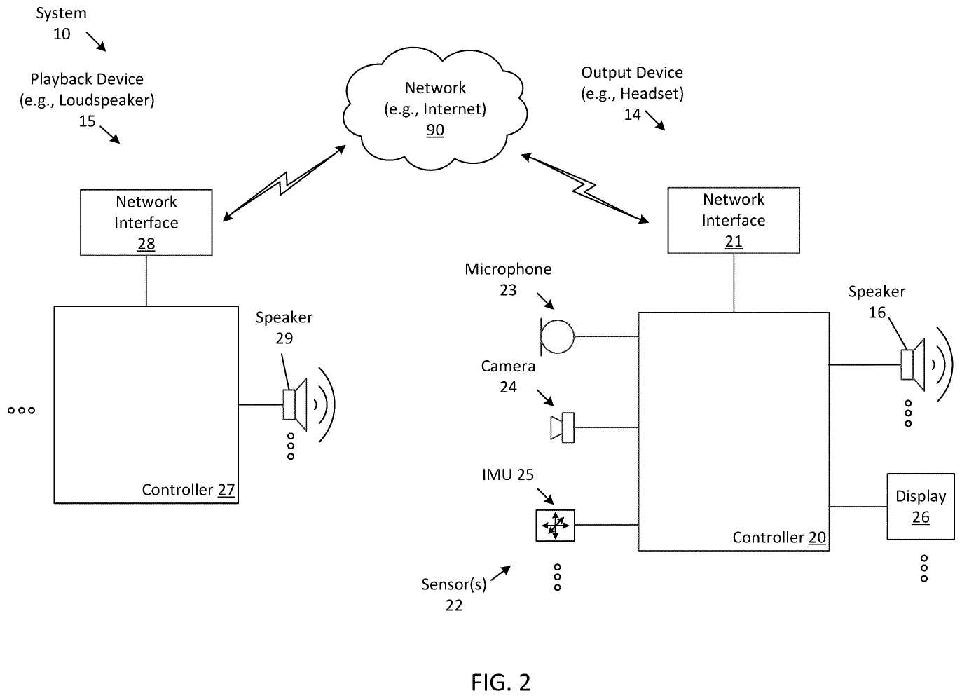

FIG. 2 shows the system 10 that includes the playback device 15 and the output device 14 which may be configured to be communicatively coupled to one another according to one aspect via the network (e.g., Internet) 90.

In one aspect, the playback device 15 may be any electronic device that is configured to playback audio content and/or perform networking operations. As shown, the playback device 15 includes a controller 27, a network interface 28, and a speaker 29. In one aspect, the playback device 15 may include more or fewer elements, such as having two or more speakers. In one aspect, the network interface 28 may be configured to establish a (e.g., wireless) communication link (or connection) with one or more other electronic devices, such as the output device 14, via the network 90 in order to exchange digital data.

In one aspect, the speaker 29 may be an electrodynamic driver that may be specifically designed for sound output at certain frequency bands, such as a woofer, tweeter, or midrange driver, for example. In one aspect, the speaker 29 may be a “full-range” (or “full-band”) electrodynamic driver that reproduces as much of an audible frequency range as possible. In one aspect, the speaker 29 is an extra-aural speaker that is configured to output sounds into the ambient environment. In another aspect, the speaker 29 may be an “in-device” speaker that is integrated into (e.g., a housing) of the playback device 15. For example, when the playback device 15 is a television, the device may include one or more speakers integrated into the television.

The controller 27 may be a special-purpose processor such as an application-specific integrated circuit (ASIC), a general-purpose microprocessor, a field-programmable gate array (FPGA), a digital signal controller, or a set of hardware logic structures (e.g., filters, arithmetic logic units, and dedicated state machines). The controller is configured to perform audio signal processing operations and/or networking operations. For instance, the controller 27 may be configured retrieve (e.g., one or more audio signals that includes) audio content (e.g., from over the network 90, via the network interface 28), and use the audio signals to drive the speaker 29 to output sounds of the audio content. For example, the controller 27 may be configured to stream audio content, through the network 90, from one or more remote devices, such as a server. In another aspect, the controller is configured to perform networking operations, such as communicating (via the network 90) to the output device 15. More about the operations performed by the controller 27 is described herein.

As shown, the output device 14 includes a controller 20, a network interface 21, the speaker 16, a display 26, and one or more sensors 22 that may include the microphone 23, a camera 24, and/or an inertial measurement unit (IMU) 25. In one aspect, the output device 14 may include more or fewer elements. For example, the output device 14 may include more sensors (e.g., a temperature sensor, an accelerometer, a proximity sensor, etc.). In another aspect, the output device 14 may include two or more elements, such as having two or more microphones, speakers, and/or displays.

In one aspect, the one or more sensors 22 may be configured to detect the environment (e.g., in which the output device 14 is located) and produce sensor data based on the environment. The microphone 23 may be any type of microphone (e.g., a differential pressure gradient micro-electro-mechanical system (MEMS) microphone) that is configured to convert acoustical energy caused by sound wave propagating in an acoustic environment into a microphone signal. As described herein, the microphone 23 may be a (e.g., reference) microphone that is arranged to sense ambient sounds. In another aspect, the microphone 23 may be an error (or internal) microphone that is arranged to capture sounds within a user's ear canal, while the output device 14 is being worn by the user. In some aspects, the output device 14 may include at least one of both types of microphones.

In one aspect, the camera 24 is a complementary metal-oxide-semiconductor (CMOS) image sensor that is capable of capturing digital images including image data that represent a field of view of the camera, where the field of view includes a scene of an environment in which the device 14 is located. In some aspects, the camera may be a charged-coupled device (CCD) camera type. The camera is configured to capture still digital images and/or video that is represented by a series of digital images. In one aspect, the camera may be positioned anywhere about the device. In some aspects, the device may include multiple cameras (e.g., where each camera may have a different field of view). The IMU 25 may be an electronic device that is designed to measure the position and/or orientation of the output device 14.

The display 26 is designed to present (or display) digital images or videos of video (or image) data. In one aspect, the display 26 may use liquid crystal display (LCD) technology, light emitting polymer display (LPD) technology, or light emitting diode (LED) technology, although other display technologies may be used in other aspects. In some aspects, the display 26 may be a touch-sensitive display screen that is configured to sense user input as input signals, which may be provided to the controller 20 as user input. In some aspects, the display may use any touch sensing technologies, including but not limited to capacitive, resistive, infrared, and surface acoustic wave technologies.

As described herein, each of the devices may include one or more elements. In one aspect, at least some of the elements may be a part of (or integrated within) a housing of each respective device. In another aspect, either of the devices may include one or more elements described herein. For example, the playback device 15 may include one or more displays, one or more microphones, and/or one or more cameras. In another aspect, rather than (or in addition to) having elements integrated within each device, one or more of the elements may be separate electronic devices that are communicatively coupled (e.g., via the network interfaces) with the controllers. For instance, the microphone 23 may be (a part of) a separate device that is (e.g., wirelessly) communicatively coupled to the controller 20, which transmits one or more microphone signals (as audio digital data) to the controller.

In one aspect, the output device 14 may be configured to communicatively couple with the playback device 15, via the network 90, such that both devices may be configured to communicate with one another using any communication protocol. In one aspect, the network 90 may be any type of computer network, such as a wide area network (WAN) (e.g., the Internet), a local area network (LAN), etc., through which the devices may exchange data between one another and/or may exchange data with one or more other electronic devices, such as a remote electronic server. In another aspect, the network may be a wireless network such as a wireless local area network (WLAN), a cellular network, etc., in order to exchange digital (e.g., audio) data. With respect to the cellular network, the output device 14 may be configured to establish a wireless (e.g., cellular) call, in which the cellular network may include one or more cell towers, which may be part of a communication network (e.g., a 4G Long Term Evolution (LTE) network) that supports data transmission (and/or voice calls) for electronic devices, such as mobile devices (e.g., smartphones). In another aspect, the devices may be configured to wirelessly exchange data via other networks, such as a Wireless Personal Area Network (WPAN) connection. For instance, the output device 14 may be configured to establish a wireless connection with the playback device 15 via a wireless communication protocol (e.g., BLUETOOTH protocol or any other wireless communication protocol). During the established wireless connection, the devices may exchange (e.g., transmit and receive) data packets (e.g., Internet Protocol (IP) packets) with the digital (e.g., audio) data, which may include a representation of audio content that is being played back by the playback device 15.

The controller 20 may be configured to drive the speaker 16 with one or more (e.g., input) audio signals to cause the output device 14 to playback (or output) audio content of the one or more audio signals. The controller may be configured to receive the audio signals from one or more software applications, which may be executed by (e.g., the controller 20 of) the output device and/or may be executed by one or more other electronic devices that may be communicatively coupled to the output device. For example, the input audio signals may be associated with audio content from an audio playback (music) software application, which may stream audio content to the output device via the network 90. In another aspect, the controller may receive sounds, as audio data from other types of software applications, such as a VPA application, a navigation application, a messaging application, a telephony application, an alarm application, etc. In another aspect, the audio signals may be associated with system sounds of the system 10. For example, system sounds may be associated with an operating system that may be executed by the controller 20. As a result, the controller may receive different audio content (as one or more audio signals) from different software applications (and/or system sounds) for playback (e.g., simultaneous, or contemporaneous playback). The controller 20 may be configured to perform selective audio playback or partial audio handoff operations so that one or more playback devices within a vicinity of the output device may playback a portion of audio content that would otherwise be played back by the output device (e.g., if the output device were not within the vicinity of the loudspeaker devices). More about the selective audio playback operations is described herein.

The controller 20 may be configured to perform other operations, such as other audio signal processing operations and/or networking operations. For example, the controller 20 may perform an acoustic transparency function in which sound played back by the one or more (e.g., internal) speakers the output device 14 may be a reproduction of the ambient sound that may be captured by the device's microphone(s) in a “transparent” manner, e.g., as if the output device 14 was not being worn by (e.g., over the cars of) the user. The controller 20 may process at least one microphone signal captured by the microphone 23 and filter the signal through a transparency filter, which may reduce acoustic occlusion due the output device 14 being on, in, or over the user's ear, while also preserving the spatial filtering effect of the wear's anatomical features (e.g., head, pinna, shoulder, etc.). The filter also helps preserve the timbre and spatial cues associated with the actual ambient sound. In one aspect, the filter of the acoustic transparency function may be user specific according to specific measurements of the user's head. For instance, the output device 14 may determine the transparency filter according to a head-related transfer function (HRTF) or, equivalently, head-related impulse response (HRIR) that is based on the user's anthropometrics. Thus, sound produced by the playback device 15 may be captured by the microphone 23 of the output device and may be heard by the user through the performance of the acoustic transparency function upon the microphone signal to produce one or more speaker drivers for driving the speaker 16.

In some aspects, the controller 20 may perform other audio signal processing operations. For instance, the controller 20 may perform an active noise cancellation (ANC) function to cause the speaker 16 to produce anti-noise in order to reduce ambient noise from the environment that is leaking into the user's ears. The ANC function may be implemented as one of a feedforward ANC, a feedback ANC, or a combination thereof. As a result, the controller 20 may receive a reference microphone signal from a microphone that captures external ambient sound. In another aspect, the controller 20 may perform any ANC method to produce the anti-noise.

In another aspect, the controllers 20 and/or 27 may be configured to perform other audio signal processing operations. As an example, when the output device 14 includes two or more (e.g., extra-aural) speakers, the controller 20 may perform sound-output beamformer operations to project one or more sounds towards particular locations in space. For example, in the case in which the speakers 16 of the output device are extra-aural speakers, the speakers of the output device may produce a beam that includes audio content and is directed towards at least one of the user's ears. For instance, when the output device is an open-back headset, the sound of the beam may pass through a portion of the headset and into the user's cars. The controller 20 may include a sound-pickup beamformer that can be configured to process the audio (or microphone) signals produced two or more external microphones of the output device 14 to form directional beam patterns (as one or more audio signals) for spatially selective sound pickup in certain directions, so as to be more sensitive to one or more sound source locations. For instance, the controller may use the sound-pickup beamformer to capture sound produced by the playback device 15.

In one aspect, the system 10 may include more devices than illustrated therein. In particular, the system 10 may include two or more playback devices. For example, referring to FIGS. 1a and 1b, the room 18 may include two or more playback devices 15, such as a smart speaker and a laptop computer. In which case, the output device 14 may be configured to communicate with either (or both) of the devices via the network 90 in order to exchange digital data. When there are two or more playback devices the system 10 may be configured to perform selective audio playback on one or more of the playback devices. More about selective audio playback using multiple playback devices is described herein.

In some aspects, the system 10 may include other devices, such as a companion device that may be configured to communicatively couple with the output device 14, and may be configured to exchange data over a wireless data connection. The companion device may be an electronic device, such as a smart phone, which may transmit audio data for playback by the output device. For example, as described in FIG. 1a, the output device may be configured to playback application sounds and/or system sounds. Such sounds may originate from one or more software applications being executed by a companion device, and that are transmitted to the output device for playback. In addition, the companion device may be configured to communicatively couple the output device with the playback device 15 via the network 90. For example, the companion device may be a smart phone that may be configured to establish a wireless data connection with both the playback device 15 and the output device 14, via the network 90 in order to facilitate data exchange between both devices.

In another aspect, the companion device may be configured to perform one or more other operations described herein, such as selective audio playback operations. In which case, the companion device may receive one or more sounds, such as a musical composition and application sounds from software applications executing on the companion device, and may select which sounds are to be played back by the playback device 15 and which sounds are to be played back by the output device 14. Upon determining which sounds are to be played back by the output device, the companion device may transmit (e.g., via a wireless connection) the audio data that includes the sounds to the output device 14 for playback. The companion device may also transmit audio data to the playback device 15 and/or may transmit a request (as a control signal) to the playback device to cause the playback device to stream one or more sounds for playback.

As described herein, the controllers 20 and/or 27 are configured to perform digital signal processing operations, such as selective audio playback, audio signal processing operations and networking operations. In one aspect, operations performed by the controllers may be implemented in software (e.g., as instructions stored in memory and executed by either controller) and/or may be implemented by hardware logic structures as described herein.

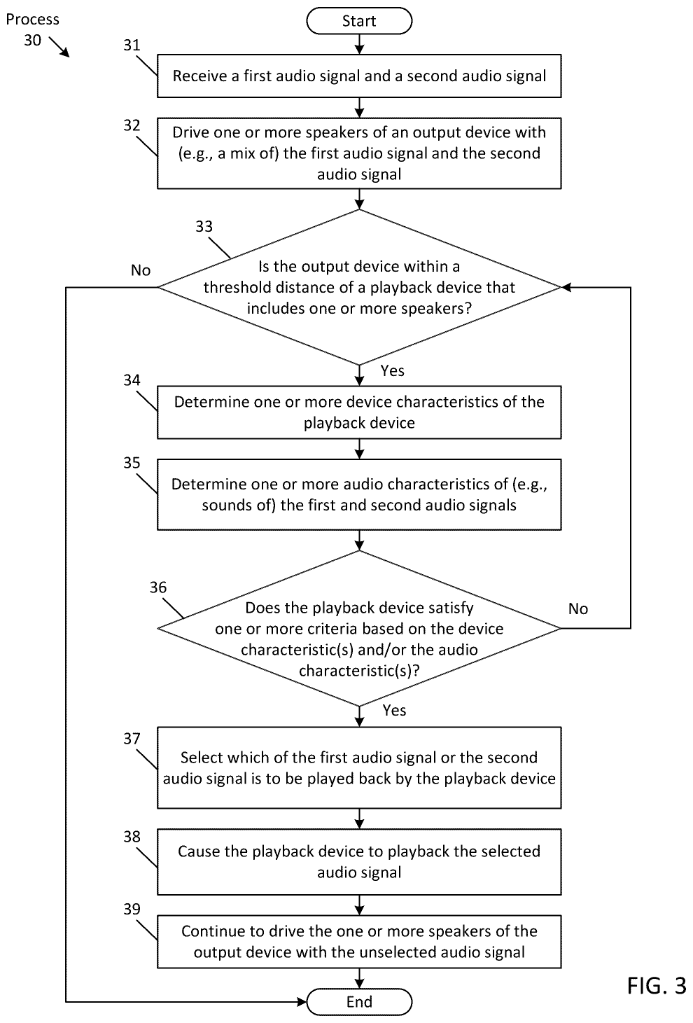

FIGS. 3-5 are flowcharts of processes 30, 40, and 50, respectively for performing one or more audio signal processing operations for selective audio playback. In one aspect, the processes may be performed by one or more devices of the system 10, as illustrated in FIGS. 1a, 1b, and 2. For instance, at least some of the operations of one or more of these processes may be performed by (e.g., the controller 20 of) the output device 14. As a result, at least some of the operations described herein may be with reference to FIGS. 1a, 1b, and 2. In another aspect, at least some of the operations may be performed by another device, such as the playback device 15 and/or a remote server communicatively coupled to the playback device and the output device.

Turning to FIG. 3, this figure is a flowchart of one aspect of a process 30 for selective audio playback. The process 30 begins with the controller 20 receiving a first audio signal and a second audio signal (at block 31). In particular, the controller may receive audio content as audio signals from one or more software applications that are being executed by the system 10. One of the audio signals may be received from a VPA application, where the audio signal includes one or more VPA sounds, while the other audio signal may be received from a navigation application that provides audible navigation instructions. In another aspect, an audio signal may be a downlink signal of a call with another electronic device of the telephony application. In another aspect, an audio signal may include user-desired audio.

In one aspect, the audio signals may be associated with a piece of audio content. The audio signals may include one or more different sounds or portions of the audio content. For example, in the case in which the piece of audio content is a soundtrack of a motion picture, the first audio signal may include dialog of the soundtrack, and the second audio signal may include other sounds, such as background sounds of the soundtrack. As another example, when the piece of audio content is a musical composition, the audio signals may include different sounds, such as the first signal including vocals while the second signal includes sounds of one or more instruments. In another aspect, the audio signals may include one or more audio channels of the audio content. For instance, in the case in which the audio content is of a particular audio format, such as a surround sound format (e.g., 5.1 surround sound), the audio signals may include one or more audio channels of the surround sound format. As another example, in the case in which the audio content includes a downlink signal of a telephone (or Voice over-IP) call captured by one or more microphones of an electronic device. In which case, an audio signal may include speech of a user of the electronic device and another audio signal may include other sounds such as background noise.

In another aspect, the audio signals may include one or more sounds of audio content. For example, in the case in which the user of the output device is participating in an extend reality (XR) environment, such as a MR environment, the audio signals may include one or more sounds of (e.g., one or more sound objects from within) the XR environment. In particular, the output device may receive audio signals of a XR environment application of which the user of the output device is participating, where the first audio signal may include a first sound and the second audio signal may include a second sound, where both sounds are associated with the XR environment in which the user of the output device is participating. For example, the sounds may be associated with one or more other users who are participating within the XR environment (e.g., sounds of avatars of those users who are within the environment). As another example, the sounds may be associated with virtual objects within the XR environment, such as a door slamming or a dog barking. In another embodiment, the signals may include any type of virtual sound.

The controller 20 drives one or more speakers of the output device with (e.g., a mix of) the first audio signal and the second audio signal (at block 32). In one aspect, the controller may spatially render at least one of the audio signals to provide the user with the perception that one or more sounds of the audio signal originates from a particular location in the environment. In particular, the controller may produce a spatially rendered audio signal by spatially rendering at least one of the audio signals, and using the spatially rendered audio signal to drive one or more speakers. For instance, when the output device is a headset, the controller may spatially render at least one of the signals (or the signal may include a spatially rendered signal), such that when used to drive a speaker, a user of the output device may perceive a virtual sound source associated with the signal at a location within the environment. Specifically, to spatially render an audio signal the controller may apply a spatial filter (e.g., a head-related transfer function (HRTF)) to the audio signal based on a desired location (or direction) from which at least one sound of the signal is to originate when used to drive the speaker. For example, upon applying the HRTF, the controller may produce one or more binaural audio signals that may be used to drive two or more speakers of the output device.

The controller 20 determines if the output device is within a threshold distance of a playback device that includes one or more speakers (at decision block 33). In one aspect, the threshold distance may be a predefined distance. In another aspect, the controller may determine whether the output device is within an acoustic audible range of the playback device in which a sound produced (e.g., at a particular output level) by the playback device may be perceived by a user of the output device. This determination may be based on sound within the ambient environment that may be captured by the microphone 23. For instance, the controller may receive a microphone signal that includes a sound captured by the microphone 23, where the sound may be produced by the playback device. In one aspect, the controller may identify the sound as being produced by the playback device based on information (e.g., metadata), which may be received by the playback device. The controller may determine whether the sound of the signal has a sound level above a threshold. If not, this may mean that the user of the output device may be unable to hear (or may not be able to sufficiently hear) sound that may be produced by the playback device. As another example, the output device may receive (or determine) playback characteristics of the playback device, such as its sound output level (e.g., volume level) of its sound output, and may compare that sound output level with the sound level of the captured sound. If the difference is above a threshold, this may indicate that the user may be able to hear the sound produced by the playback device (and may therefore be within the threshold distance).

In another aspect, the controller may determine whether the output device is within the threshold distance based on sensor data of one or more sensors. For instance, the controller may receive image data captured by the camera 24, and may use the image data to identify a playback device (e.g., based on an image recognition algorithm), and determine its location with respect to the output device to determine the distance between both devices. In another aspect, the distance between the two devices may be determined based on motion data (e.g., from the IMU 25). For instance, upon determining the location of the playback device, the controller 20 may determine the distance between the two devices based on (e.g., changing) motion data of the output device (e.g., as a user of the output device moves within the environment).

In another aspect, this determination may be based on data obtained by the output device 14. The output device 14 may obtain data from the playback device 15, which may indicate its location with respect to the output device. For example, the playback device 15 may provide location information (e.g., Global Positioning System (GPS) data) to the output device 14, from which the location of the playback device may be determined. In another aspect, the distance between the two devices may be determined based on a wireless connection between the two devices. For instance, the output device 14 may determine a location of the playback device 15 based on a received signal strength indicator (RSSI) of the wireless connection. In either case, the output device 14 may receive data from the playback device upon establishing a wireless connection.

In one aspect, to determine whether the output device 14 is within the threshold distance, the output device may operate in a discovery mode in which the output device 14 may (e.g., periodically) determine whether there are other (e.g., wireless) devices within a vicinity of the output device. Upon detecting another device, such as the playback device 15, the output device 14 may establish a wireless connection (e.g., BLUETOOTH connection) with the detected device and the output device may determine the distance of the device from the output device 14, as described herein. For instance, upon establishing a wireless connection, the playback device may transmit GPS data to the output device.

If the output device 14 is within the threshold distance, the controller 20 may determine one or more device characteristics of the playback device (at block 34). As described herein, the device characteristics may indicate whether the device is adequate for audio playback. In one aspect, adequacy may be based on whether the playback device is capable of playing back at least a portion of audio content that is being output by the output device, or whether the playback device includes one or more characteristics that meet or exceed a threshold. Upon discovering that a playback device 15 is within the threshold distance, the controller 20 may cause the output device 14 to transmit a request to the playback device for the device characteristics. The characteristics may include at least one of a sensitivity of the playback device, a power rating of the electronic device, and/or a playback availability of the device. These characteristics may be associated with the one or more speakers of the device. For example, the sensitivity may be a speaker sensitivity, and the power rating may be the speaker's power rating (e.g., in Watts). In which case, one or more of these characteristics may indicate a quality of sound playback by the playback device. For example, a first device may provide better sound quality than a second device, when the first device has a higher speaker sensitivity and/or higher power rating than the second device. The playback availability may indicate whether the playback device is already playing back audio content (e.g., streaming a musical composition independently from the output device). In another aspect, the controller may determine other characteristics, such as the location of the playback device 15 with respect to the output device 14.

In one aspect, the controller 20 may determine device characteristics based on an identification of the playback device 15. For example, the controller may identify the playback device, through the use of object recognition for example, and determine one or more characteristics using the identification. In particular, the controller 20 may perform a table lookup into a data structure that associates images of playback devices with one or more device characteristics. As another example, the controller may determine characteristics based on data received from the playback device. For instance, the playback device may transmit at least some of the device characteristics. As another example, the playback device may transmit identifying information (e.g., a model number, a serial number, etc.), from which the controller 20 may use to determine device characteristics (e.g., performing a table lookup using the model number).

The controller 20 determines one or more audio characteristics of (e.g., sounds of) the first and second audio signals (at block 35). In particular, the audio characteristics may provide an indication of whether one or more of the audio signals may be handed off to one or more playback devices for playback. Since the playback device may be a loudspeaker device, the device may produce sound output into the environment that may be heard by others, including the user of the output device. As a result, the audio characteristics may indicate whether one or more sounds of an audio signal is of a private nature (e.g., to only be heard by a user of the output device) or non-private nature (e.g., to be heard by the user of the output device and/or others within the environment). In one aspect, to determine whether sounds are private, the controller 20 may analyze the signals for one or more words or phrases that may be associated with a private conversation. As another example, the controller may determine whether sounds are private based on metadata associated with the signals.

Other audio characteristics may include a spectral analysis of an audio signal (e.g., which may indicate power or signal levels with respect to one or more frequency components) and/or a type of audio content (sound) of the audio signal. For instance, when the audio signals are associated with a soundtrack of a motion picture, the type of audio content may include dialog, background sounds, etc., of the motion picture. The type may also indicate a description of the sound(s) of the audio signal. As described herein, the audio signal may include sound(s) of an XR environment. In which case, the type of sound may indicate a relationship to an object, such as being a barking noise of a virtual dog in the XR environment or speech of a virtual person within the XR environment. The audio characteristics may include spatial information (or characteristics) of audio content associated with the audio signals. In particular, the spatial information may include a location and/or distance that a sound of the audio signal is to be spatially rendered with respect to a listening position of the user 13. With respect to the XR environment, the spatial information may indicate the virtual location within the XR environment at which a virtual sound source of one or more sounds of an audio signal is to be located. In another aspect, the audio characteristics may include other information that may be used for spatially rendering an audio signal. In some aspects, the characteristics may include a signal level of the audio signal(s).

In another aspect, an audio characteristic may include an indication that (e.g., one or more sounds of) an audio signal is shared with another electronic device that is within the environment with the output device. Specifically, the controller 20 may determine whether the output device 14 and one or more other electronic devices are playing back a same audio signal (e.g., simultaneously). As described herein, the user of the output device may participate within an XR environment. For example, the speaker 16 of the output device 14 may playback sounds of the XR environment and/or the display 26 of the output device 14 may display a visual representation of the XR environment that may include virtual objects and/or avatars of other users who are participating within the XR environment. In which case, other electronic devices may participate within a same XR environment. As a result, one or more sounds within the XR environment may be shared between devices. As an example, two people, both using different output devices, may participate in a virtual musical concert, where both of the output devices may playback music of the virtual musical concert. As a result, the controller may determine whether a sound (e.g., music from the virtual musical concert) associated with a received audio signal may be a shared audible experience between multiple devices. This may be the case when the music is originating from a virtual stage within the XR environment in which both users are participating.

In another aspect, an audio characteristic may include an indication that a sound is speech of a user of another electronic device. Continuing with the previous example, when a user of the output device 14 is participating within an XR environment, another user may participant in that environment such that sound of the XR environment may include speech of this other user who is also participating within the XR environment (using another electronic device). In which case, the audio content received by the controller may include sounds of the XR environment that include the speech of the other user and other sounds. The controller may determine that a sound of the XR environment is the speech of another user based on a speech analysis of the audio content.

In one aspect, the controller 20 may determine the audio characteristics using one or more methods. For instance, the controller may perform a spectral analysis upon an audio signal to determine the spectral content of the signal. In one aspect, the spectral analysis may be used to determine other characteristics. For example, the controller may determine the type of the audio signal using the analysis. In particular, the controller may perform a table lookup into a data structure that associates types of audio signals with spectral content. In another aspect, the controller may determine audio characteristics based on data (e.g., metadata) associated with the audio signals. For instance, in the case in which the audio signals are associated with a piece of audio content, the characteristics may be determined based on data of the piece of audio content. In another aspect, the information relating to the audio signals may be retrieved (e.g., requested) from a remote storage (e.g., remote server).

In another aspect, the controller 20 may determine one or more audio characteristics based on information (or data) associated with the audio signals. As described herein, the audio signals may include sounds of a piece of audio content, such as a soundtrack of a motion picture. In which case, the controller 20 may perform a visual analysis of video content associated with the motion picture to determine one or more audio characteristics. For example, the controller may analyze a scene of a motion picture to determine that a person is talking (e.g., based on detected facial features, such as mouth movements). In which case, the controller may determine a type of sound of an audio signal as dialog based on the facial features. the playback device as a microphone signal. Similarly, with respect to an XR environment, the controller may perform a visual analysis upon video data associated with the XR environment to determine audio characteristics. For example, the controller may determine the virtual location associated with a virtual sound source based on a location of a corresponding virtual object within the XR environment.

The controller 20 determines whether the playback device satisfies a criterion (or one or more criteria) based on the one or more device characteristics and/or the one or more audio characteristics (at decision block 36). For example, the one or more criteria being satisfied may indicate that the playback device is adequate to playback one (or both) of the audio signals. In particular, the controller determines whether the playback device is to playback one or more sounds of the audio content. The controller may determine the playback device's adequacy based on one or more determined device characteristics and/or one or more determined audio characteristics of at least one of the audio signals. For instance, the controller may determine whether the playback device 15 is adequate for audio playback based on the device's playback availability. If the device is available for audio playback, the device may be deemed adequate. In another aspect, adequacy may be based on whether the playback device satisfies criteria, such as sensitivity and/or power rating, both of which may indicate an amount of sound output that the device may be capable of. In which case, the controller 20 may determine that the device 15 is adequate based on whether the sensitivity and/or power rating are above respective (e.g., different) thresholds. In one aspect, these thresholds may be based on the audio signals that the controller 20 is trying to offload to the playback device. In another aspect, adequacy may be based on the location or distance of the device 15 with respect to the output device, such as being at a particular location within the environment (at which a sound may be played back) and/or at a particular distance from the output device. In some aspects, adequacy may be based on whether one or more characteristics are satisfied, such as being available for playback and having a sufficient sensitivity and/or a sufficient power rating. In another aspect, availability may be based on whether the playback device is currently playing back audio content. In which case, the playback device may be available when not currently playing back audio content or may be playing back audio content below a sound level threshold.

In another aspect, adequacy may be based on one or more determined audio characteristics and one or more determined device characteristics. In particular, the controller may determine whether the playback device certain device and audio characteristics are satisfied (e.g., above respective thresholds). For example, the controller 20 may determine that an audio signal includes a significant amount (e.g., above a threshold) of low-frequency acoustic energy based on a spectral analysis of the audio signal. In which case, in order to efficiently playback the audio signal the electronic device may require a high-power rating (e.g., above a threshold) in order to effectively produce the high amount of low-frequency acoustic energy. As a result, if the playback device does not include a high enough power rating, the controller 20 may determine that the playback device is not adequate.

As another example, the controller may determine that an audio signal is to be spatially rendered at a location of the playback device with respect to (e.g., the user who is wearing or holding) the output device 14. In particular, the controller may determine that the audio signal is to be spatially rendered at a virtual sound source located at a virtual location within the XR environment (e.g., based on spatial information of the audio content), and may determine whether the virtual location corresponds to a physical location of the electronic device within the (physical environment) with respect to the output device. For instance, this may be the case when the virtual sound source is a user's avatar within the XR environment, and the audio signal includes speech of the user. If so, the controller may determine that the playback device is to playback the sound. If not, however, the controller may proceed back to the decision block 33 to determine whether another electronic device is within a threshold distance of the output device.

If, however, the playback device is adequate, the controller 20 may select which of the first audio signal or the second audio signal is to be played back by the electronic device (at block 37). In particular, the controller 20 may select (or assign) a portion of sounds that are currently being played back by the output device or are going to be played back by the output device in order to perform a partial audio handoff to the playback device. In one aspect, this decision may be based on audio characteristics of the audio signals. Specifically, the selection may be based on a comparison of corresponding audio characteristics. For example, the output device may compare the spectral content of the audio signals and select the audio signal that has higher spectral energy (e.g., above a threshold) across one or more frequency components, such as low-frequency components. As another example, the controller 20 may select the audio signal that includes non-private content, since the playback device will playback the audio signal into the environment. As another example, the controller 20 may determine which of the audio signals that the playback device will play back based on the types of sounds of the audio signals. For example, the controller 20 may determine that the electronic device is to playback background sounds, while the output device may playback dialog of a soundtrack of a motion picture. As another example, the controller may select an audio signal shared between the output device and another electronic device that may be within a vicinity of the playback device, as described herein. As another example, the controller 20 may select an audio signal that includes speech of another user's avatar within an XR environment in which the user of the output device 14 is participating.

In another aspect, the controller 20 may select audio signals based on device characteristics of the playback device and audio characteristics of the audio signals. Specifically, the controller 20 may select the sound that will be played back by the playback device that was used to determine whether the playback device satisfied one or more characteristics. As described herein, the controller may determine whether the playback device is located at (or near) a virtual location at which a sound would be otherwise spatially rendered by the output device. In which case, the controller 20 may select the audio signal that includes the sound that is to be spatially rendered at a virtual location or direction that may be associated with a physical location of the playback device with respect to the output device.

The controller 20 causes the playback device to playback the selected audio signal (at block 38). In particular, the output device 14 may assign the playback device with the audio reproduction responsibilities for playing back the selected audio signal. For example, the controller 20 may cause the output device 14 to transmit, via a wireless connection, a control signal to the playback device to cause the playback device to playback a portion of the of the audio content (e.g., the selected audio signal) through the device's one or more speakers. For instance, the playback device may stream the audio signal from a remote device, such as a remote server. In another aspect, the output device may transmit the selected audio signal to the playback device for playback.

In one aspect, the controller 20 may transmit other information to the playback device for use in playing back the audio signal. For example, the playback device may include two or more speakers, which may be used to spatially reproduce sound(s) of the selected audio signal. In particular, the playback device may receive location (e.g., directional) information from the output device that indicates a location of the output device with respect to the playback device. The playback device may produce a sound directional beam pattern, using two or more speakers, which includes the audio signal, and may direct the beam pattern toward the output device 15 (according to the location information). As a result, sound of the audio signal may be spatialized towards a location within the physical environment, such as towards the user of the output device. In one aspect, such a spatialization of the selected sound may sound better (e.g., provide a better spatial experience) than using sound output of the output device.

The controller 20 continues to drive the one or more speakers of the output device with the unselected audio signal (at block 39). In particular, the controller 20 may cease to playback the portion of the audio content, which is being played back by the playback device, and may continue to playback other sounds of the audio content through the speaker(s) of the output device. For example, while the playback device may play back non-private audio content, the output device may (continue to) play back audio content that is of a private nature. In one aspect, the playback of the selected and unselected audio signals by the playback device and the output device, respectively, may be cross-faded such that playback transitions between the output device to the playback device. For instance, the controller may fade down playback of the selected audio signal, while the playback device fades up playback of the selected audio signal.

As a result, the process 30 allows the system 10 to perform a partial handoff of audio reproduction by the output device 14. In one aspect, the user of the output device may perceive at least a portion of the sound played back by the playback device 15. For example, the user of the output device may hear sound playback by the playback device due to the output device 14 not or partially occluding one or both of the user's ear canals, thereby allowing sound to pass from the environment into the user's ears. As an example, the output device 14 may be an open-back headset, as described herein. As another example, the output device may be a head mounted device, which may include a display, and that may include one or more extra-aural speakers. In another aspect, the output device may perform the acoustic transparency function in order to pass-through sound playback by the playback device. In this example, the output device 14 may be partially or fully occluding the user's ear canal from the environment, and may use one or more speakers 16 to reproduce one or more sounds from the environment captured by the microphone 23 according to the acoustic transparency function, as described herein. In another aspect, to capture the sound of the playback device the output device may use two or more microphones 23 to produce a sound-pickup beam pattern in a direction of the playback device, as described herein.

As described herein, the controller 20 may cause the playback device to playback a selected audio signal, such as a signal that includes speech of another user who may be participating within an XR environment. In one aspect, the controller may adjust the visual representation of the XR environment that may be displayed on the display 26. For instance, when the other user is visually represented by an avatar within the XR environment, the controller may move the avatar to a virtual location within the XR environment that may correspond to a physical location of the playback device with respect to the output device (and/or with respect to an avatar of the user of the output device). As a result, the user of the output device may perceive the speech of the other person to originate from the person's moved avatar.

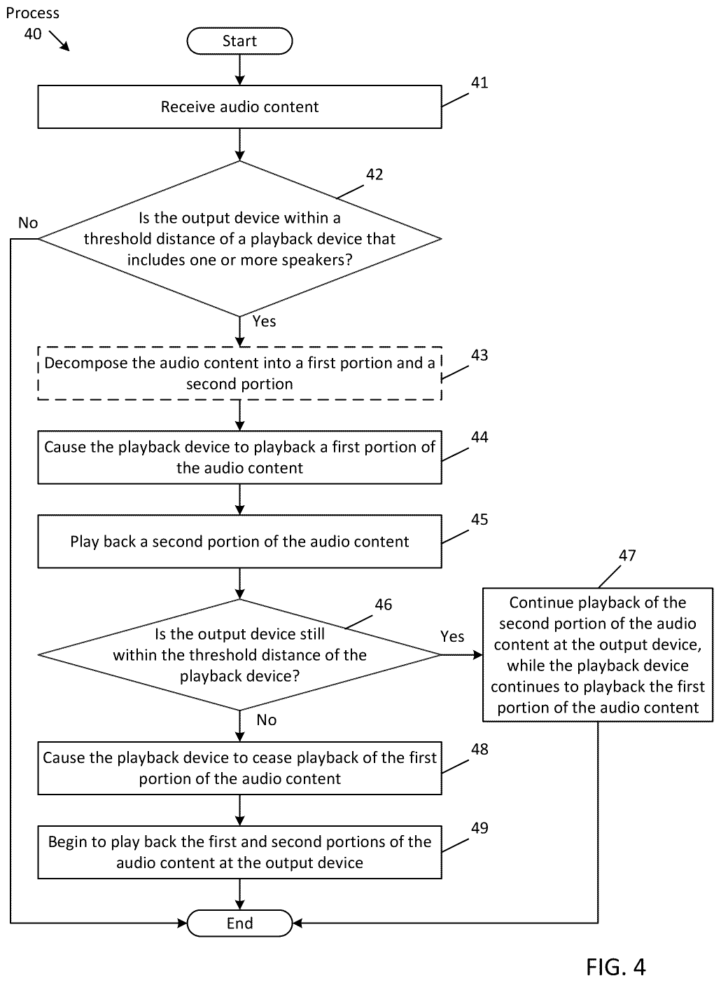

FIG. 4 is a flowchart of another aspect of a process 40 for selective audio playback according to one aspect. The controller 20 may perform the process to determine whether the playback device is to playback one or more portions (sounds) of audio content, and in response, cause the playback device to playback the one or more portions, while the output device may (continue) to playback other portions of the audio content. The process 40 begins with the controller 20 receiving audio content (at block 41). As described herein, the audio content may include a piece of audio content (that has one or more audio signals), such as a soundtrack of a motion picture or audio of a XR environment. In one aspect, the controller 20 may optionally playback the audio content through one or more speakers 16 of the output device 14. For example, in the case in which the output device is a pair of in-ear headphones with a speaker for each car, the controller 20 may produce two or more binaural audio signals by spatially rendering the one or more audio signals of the audio content, and use the binaural audio signals to drive the speakers of the in-ear headphones.

The controller 20 determines if the output device 14 is within a threshold distance of the playback device 15 that includes one or more speakers (at decision block 42). As described herein, the controller 20 may perform one or more operations to determine whether a playback device, such as a smart speaker or laptop computer is within the environment of the output device (e.g., within an audible range of the output device), where the playback device may include (or be communicatively coupled to) one or more speakers or loudspeakers to project sound into the environment.

If so, the controller 20 (optionally) decomposes the audio content into a first portion and a second portion (at block 43). In particular, the controller may analyze the audio content and identify (or select) one or more sounds (as the first portion) to be played back by the playback device 15, while one or more other (e.g., unselected) sounds of the audio content (as the second portion) may be played back (or may continue to be played back) through the output device 14. In another aspect, the controller may decompose the audio content into a first subset of one or more audio signals that includes one or more sounds for payback by the playback device and a second subset of one or more audio signals that includes one or more sounds for playback by the output device.

In one aspect, decomposition may be based on one or more audio characteristics of the audio content that indicate whether sound should be played back at the output device or the playback device. For example, the controller 20 may perform an acoustic analysis upon the audio content to identify one or more sounds of the audio content. As an example, when the audio content include audio data of an audio call (e.g., a telephony call or a Voice-over-IP (VOIP) call) that is being conducted between the output device 14 and a remote electronic device, the controller 20 may identify speech of the audio call (e.g., speech of a user of the remote electronic device) and identify background (or ambient) sounds (e.g., background music) that are being captured by a microphone of the remote electronic device and transmitted through the call. The controller may select (or assign) the background sounds for playback by the playback device, and/or may select the identified speech for playback by the output device. As another example, the controller may identify sounds of the audio content as private or non-private, and may select at least some non-private sounds for playback through the playback device. As another example, the controller may decompose sounds of an XR environment, where sounds that may be shared between two or more output devices and/or sounds originating at a location of the playback device may be selected for playback by the playback device. The controller may identify an indication that a sound is being shared between devices (e.g., based on data of the devices). In another aspect, the controller may identify speech within the sound of the XR environment (from other sounds, such as background noises within the environment), which may belong to another user who is participating within the XR environment.

In another aspect, the controller may decompose the audio content based on device characteristics of the playback device and/or audio characteristics of one or more sounds of the audio content. For example, the controller may determine device characteristics such as the device's location within the environment, and determine whether any sounds of the audio content are to be spatially rendered at a virtual location that corresponds to the device's location, with respect to the output device (the listener's position within a virtual environment). If so, those sounds may be selected for playback by the playback device 15. As another example, the controller may determine which sounds may benefit (e.g., due to their spectral content) from being played back through the playback device, based on the device characteristics, such as speaker sensitivity. In another aspect, the controller 20 may decompose the audio content based on metadata, which may be received with the audio content or retrieved separately (e.g., from a remote server).

The controller 20 causes the playback device to playback the first portion of the audio content (at block 44). Specifically, the controller may cause the output device to transmit a control signal to the playback device 15, indicating which sounds of the first portion of the audio content are to be played back. In another aspect, the controller 20 may be configured to produce and transmit one or more audio signals, from the audio content, that includes the first portion of sounds. As described herein, the first portion may include sounds such as non-private sounds, sounds associated with (virtual) sound sources that are located at a location of the playback device with respect to the output device, sounds, such as speech of a user who is participating within a XR environment. The controller 20 plays back the second portion of the audio content (at block 45). In particular, the controller 20 may produce one or more audio signals from the audio content that includes the sounds of the second portion, which may be the unselected sounds that were not assigned for playback by the playback device 15. As a result, the playback device may playback the first portion of the audio content, and the output device may playback the second portion of the audio content. In one aspect, both devices may playback their respective portions simultaneously, such that the user may perceive the played back sounds as if only one device were playing back both portions. In one aspect, these portions may be determined based on characteristics, as described herein. For example, the playback device may playback direct sound that may originate from the location of the playback device, while the output device may playback ambient sound. As an example, the direct sound may be dialog of a soundtrack of a motion picture, whereas the ambient sound may be background sounds of the soundtrack.

The controller 20 determines whether the output device 14 is still within the threshold distance of the playback device 15 (at block 46). The controller may determine whether the output device is outside of the threshold distance from the playback device by performing one or more operations, as described herein. The output device may be a portable device, such as a headset worn by a user. In which case, the output device may move about an environment as the user uses (wears) the headset, such as a user moving about a living room in which the playback device is located. In one aspect, the controller may make this determination based on sensor data from one or more sensors 22, such as the IMU 25. The controller may determine whether a location of the output device has changed, based on IMU data, and determine whether the distance between the playback device and a new location of the output device exceeds the threshold. In another aspect, the controller may make this determination using other sensors, such as the microphone 23. In this case, the controller may capture sounds produced by the playback device 15, and determine whether the output device is still within the threshold distance based on whether a signal level of the microphone signal produced by the microphone is above a sound level (e.g., sound pressure level (SPL) level).

If so, the controller 20 may cause the output device 14 to continue playback the second portion of the audio content at the output device 14, while the playback device 15 continues to playback the first portion of the audio content (at block 47). In this case, the output device may move, due to a user of the output device moving, about the environment, but stay within the threshold distance of the playback device. In one aspect, the controller may adjust or update audio characteristics and/or device characteristics based on this movement. As described herein, the sounds played back by the output device may be spatialized using one or more spatial filters (e.g., HRTFs) based on a (e.g., virtual) location with respect to the output device. As a result, the controller may update the one or more spatial filters to account for changes to the output device's location and/or orientation.

If, however, the output device 15 is outside of the threshold distance, due to the user moving outside of the environment in which the playback device is located for example, the controller 20 may cause the playback device to cease playback of the first portion of the audio content (at block 48). For example, the controller 20 may cause the output device 15 to transmit a control signal, via a wireless connection, to the playback device to cause the device to cease playback. The controller 20 begins to play back the first and second portions of the audio content at the output device (at block 49). In particular, the controller 20 may begin to playback the one or more sounds that were previously being played back by the playback device through the one or more speakers of the output device. In one aspect, the controller 20 may perform both of these operations simultaneously.

In one aspect, the controller 20 crossfade the first portion of the audio content from being played back by the playback device to being played back by the output device. In one aspect, the controller may crossfade based on the distance between the two devices. For example, upon the output device exceeding a first distance threshold, the output device may begin to playback the first portion at a first level. As the distance between the two devices increases, the output device may increase the sound level of the first portion, while the playback device may decrease its sound output. Once the output device exceeds a second distance threshold, the first portion may be played back at a second output level, whereas the playback device may cease playback.

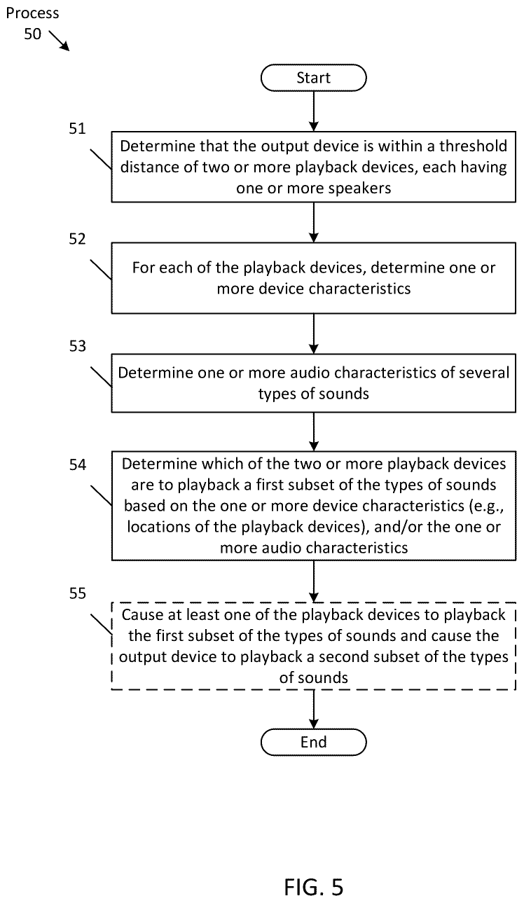

As described thus far, the system 10 may determine whether the output device 14 is within a threshold distance of a playback device 15 in order to hand off a portion of audio playback to the playback device 15. In some cases, however, an environment may include multiple playback devices. Referring to FIG. 1a, the room 18 may include the playback device 15, which may be a smart speaker and include other playback devices, such as a (smart) television, a laptop computer, and a tablet computer, all of which may include one or more integrated speakers. In which case, the system 10 may be configured to hand off similar or different portions of audio content to one or several playback devices. FIG. 5 is a flowchart of an aspect of a process 50 for determining which of one or more playback devices are to playback similar or different types of sounds according to one aspect.

Turning to FIG. 5, the process 50 begins by the controller 20 determining that the output device 14 is within a threshold distance of two or more playback devices, each having one or more speakers (at block 51). In particular, the controller 20 may perform at least some operations described herein to determine whether there are several playback devices within the environment of the output device 14. For instance, the controller 20 may make such a determination by performing an image recognition algorithm upon image data captured by the camera 24 of the output device 14. For each of the playback devices, the controller 20 may determine one or more device characteristics (at block 52). For instance, the controller 20 may determine the locations of each of the playback devices with respect to the output device. Continuing with the previous example, the controller may determine the locations of the playback devices using object recognition. In another aspect, the controller may determine other device characteristics as described herein.

The controller 20 determines one or more audio characteristics of several types of sounds (at block 53). In particular, the controller may analyze (e.g., one or more audio signals of) audio content that is to be played back or is being played back by the output device 14. In which case, the controller 20 may perform acoustic analysis of the audio content to identify different types of sounds, and/or may determine audio characteristics of those sounds, such as spatial characteristics, etc. As an example, when audio content is of a XR environment, the controller may determine audio characteristics of different sounds within the environment, such as their locations within the XR environment with respect to (e.g., an avatar of) the user of the output device 14. In another aspect, the controller may decompose sounds of audio content, such as identifying sounds of the XR environment, and may determine characteristics of those sounds. In another aspect, the controller may determine audio characteristics by performing a table lookup into a data structure that associates characteristics for different types of sounds.

The controller 20 determines which of the two or more playback devices are to playback a first subset of the types of sounds based on the one or more device characteristics (e.g., locations of the playback devices), and/or the one or more audio characteristics (at block 54). In particular, the controller 20 may be configured to determine which of the playback devices are to playback, if at all, one or more (types of) sounds of a group of sounds (e.g., of a piece of audio content). In one aspect, to determine which of the playback devices is to playback one or more sounds the controller 20 may compare one or more device characteristics between the devices. This determination may be based on whether the playback devices may be adequate for playing back one or more sounds, such as whether the device is available for audio playback. In another aspect, this determination may be based on other device characteristics, such as sensitivity and/or power rating. For example, the controller 20 may determine that one or more sounds may be played back by a first playback device that has a low (e.g., below a threshold) power rating, due to the sounds requiring low acoustic energy (e.g., being ambient noise), whereas the controller may determine that one or more sounds may be played back by a second playback device that has a high (e.g., above a threshold) power rating, due to the sounds requiring high acoustic energy (e.g., being an explosion in a motion picture).

In another aspect, the determination may be based on the locations of the playback devices with respect to the output device. As described herein, the types of sounds may be sounds of a XR environment, such as a MR environment. In which case, if played back by the output device 15, sounds may be spatially reproduced as sound sources at virtual locations within a virtual environment with respect to the user (or output device). In the case of an MR environment, the virtual locations may have corresponding physical locations within the physical environment with respect to the output device. In which case, the controller 20 may determine whether those virtual locations correspond to any locations of the playback devices. As a result, the controller 20 may determine that those playback devices may be assigned to playback the sound(s) associated with its location. In one aspect, one or more playback devices within the environment may not be assigned to playback sound. This may be the case when a playback device is not deemed adequate to playback audio content, as described herein. In another aspect, the determination may be based on the audio format of the audio content and the locations of the playback devices. For instance, the audio content may include one or more stereo audio channels. The controller may determine which playback devices are to playback which audio channels based on their location associated with the audio channel. For example, upon determining that two playback devices are located in front of the user, the controller may determine that one of the devices is to playback a left channel of the stereo audio channels and the other is to playback a right channel of the stereo audio channels.

In another aspect, the determination may be based on where sounds are being spatially rendered by the output device. For example, the output device may be spatially rendering a sound such that a user of the output device perceives a virtual sound source at a location within the environment. To determine which playback device may playback the sound, the controller may determine whether either of the playback device locations is at the location or is within a threshold distance of the location of the virtual sound source. The playback device that is at the location, within the threshold distance, or is closet to the location may be selected to playback the sound.

The controller 20 (optionally) causes at least one of the playback devices to playback the first subset of the types of sounds and causes the output device to playback a second subset of the types of sounds (at block 55). For example, in order to playback audio content that includes three sounds, the controller may cause one playback device to playback one sound, another playback device to playback another sound, and may cause the output device to playback the third sound, thereby handing off a portion of the audio content to the playback devices.

Some aspects may perform variations to the processes 30, 40, and/or 50 described in FIGS. 3, 4, and 5, respectively. For example, the specific operations of at least some of the processes may not be performed in the exact order shown and described. The specific operations may not be performed in one continuous series of operations and different specific operations may be performed in different aspects.

As described herein, the system 10 may perform selective audio playback operations to determine which sounds are to be played back by (handed off to) one or more playback devices. In which case, any sounds determined not to be played back by the one or more playback devices may be played back (e.g., by default) by the output device. In another aspect, the system 10 may determine that one or more sounds are to be played back by the output device based on at least some of the operations describe herein. For instance, upon determining that a sound is private, the system may determine that the output device is to playback the sound. As a result, upon determining that a playback device is not adequate to playback a sound, the system 10 may determine that the output device is to playback the sound.

In one aspect, at least some operations described herein may be optional, whereby the audio system may or may not perform the operations. In particular, operations (e.g., lines or blocks) that are dashed, such as block 55 in FIG. 5 may be operational. In particular, as described herein, the system 10 may receive audio content and perform selective audio playback through one or more playback devices and an output device. In another aspect, the system 10 may perform the operations described herein to assign one or more sounds to one or more devices, such that when those sounds are to be played back, the assigned device may perform the playback. For example, referring to process 50, the controller may determine that a playback device is to playback background sounds of a phone call, whereas the output device 14 is to playback speech of the call. As a result, upon receiving a future phone call, the controller may transmit a control signal to the playback device (if within the threshold distance of the output device) to playback the background sounds of the future phone call.

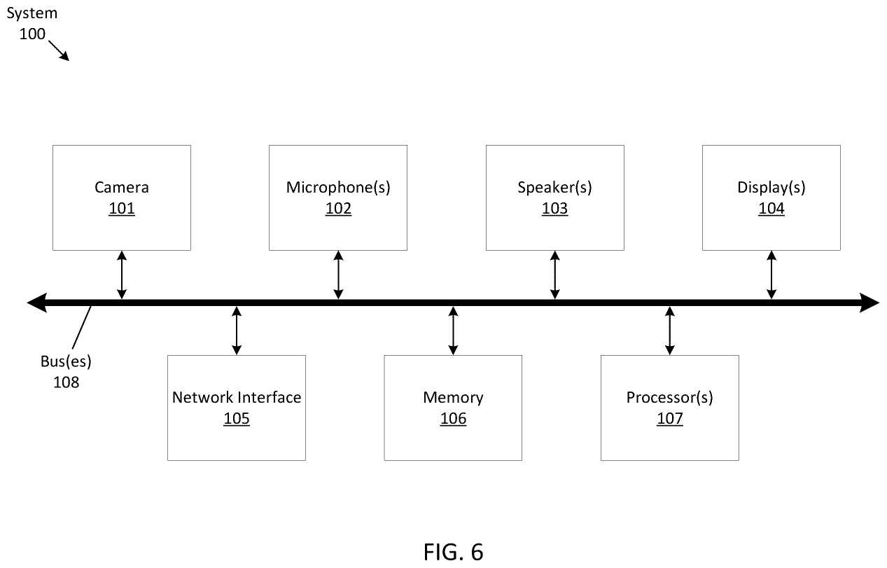

FIG. 6 shows a block diagram of audio system hardware, in one aspect, which may be used with any of the aspects described herein (e.g., playback device 15 and/or the output device 14). This audio processing system 100 may represent a general-purpose computer system or a special purpose computer system. Note that while FIG. 6 illustrates the various components of an audio processing system that may be incorporated into one or more of the devices described herein, it is merely one example of a particular implementation and is merely to illustrate the types of components that may be present in the system. FIG. 6 is not intended to represent any particular architecture or manner of interconnecting the components as such details are not germane to the aspects herein. It will also be appreciated if other types of audio processing systems that have fewer components than shown or more components than shown in FIG. 6 can also be used. Accordingly, the processes described herein are not limited to use with the hardware and software of FIG. 6.

As shown in FIG. 6, the audio processing system (or system) 100 (for example, a laptop computer, a desktop computer, a mobile phone, a smart phone, a tablet computer, a smart speaker, a HMD, a headphone, or an infotainment system for an automobile or other vehicle) includes one or more buses 108 that serve to interconnect the various components of the system. One or more processors 107 are coupled to bus 108 as is known in the art. The processor(s) may be microprocessors or special purpose processors, system on chip (SOC), a central processing unit, a graphics processing unit, a processor created through an Application Specific Integrated Circuit (ASIC), or combinations thereof. In one aspect, the processor 107 may include (or be a part of) the controller 20 of the output device 14 and/or may include or be a part of the controller 27 of the playback device 15. Memory 106 can include Read Only Memory (ROM), volatile memory, and non-volatile memory, or combinations thereof, coupled to the bus using techniques known in the art. Camera(s) 101, microphone(s) 102, speaker(s) 103, and display(s) 104 may be coupled to the bus.

Memory 106 can be connected to the bus and can include DRAM, a hard disk drive or a flash memory or a magnetic optical drive or magnetic memory or an optical drive or other types of memory systems that maintain data even after power is removed from the system. In one aspect, the processor 107 retrieves computer program instructions stored in a machine-readable storage medium (memory) and executes those instructions to perform operations described herein.

Audio hardware, although not shown, can be coupled to one or more buses 108 in order to receive audio signals to be processed and output (or played back) by speakers 103. Audio hardware can include digital to analog and/or analog to digital converters. Audio hardware can also include audio amplifiers and filters. The audio hardware can also interface with microphones 102 (e.g., microphone arrays) to receive audio signals (whether analog or digital), digitize them if necessary, and communicate the signals to the bus 108.

The network interface 105 may communicate with one or more remote devices and networks. For example, interface can communicate over known technologies such as Wi-Fi, 3G, 4G, 5G, Bluetooth, ZigBee, or other equivalent technologies. The interface can include wired or wireless transmitters and receivers that can communicate (e.g., receive and transmit data) with networked devices such as servers (e.g., the cloud) and/or other devices such as remote speakers and remote microphones.

It will be appreciated that the aspects disclosed herein can utilize memory that is remote from the system, such as a network storage device which is coupled to the audio processing system through a network interface such as a modem or Ethernet interface. The buses 108 can be connected to each other through various bridges, controllers and/or adapters as is well known in the art. In one aspect, one or more network device(s) can be coupled to the bus 108. The network device(s) can be wired network devices (e.g., Ethernet) or wireless network devices (e.g., WI-FI, Bluetooth). In some aspects, various aspects described herein may be performed by a networked server in communication with the playback device 15 and/or the output device 14.

In one aspect, although illustrated as separate components, one or more components may be a part of (or integrated) together or with an electronic device. For example, the memory 106 may be a part of one or more processors 107.

Various aspects described herein may be embodied, at least in part, in software. That is, the techniques may be carried out in an audio system in response to its processor executing a sequence of instructions contained in a storage medium, such as a non-transitory machine-readable storage medium (e.g., DRAM or flash memory). In various aspects, hardwired circuitry may be used in combination with software instructions to implement the techniques described herein. Thus, the techniques are not limited to any specific combination of hardware circuitry and software, or to any particular source for the instructions executed by the audio processing system.

In one aspect, the controller 20 may be configured to produce a spatially rendered audio signal by spatially rendering one or more audio signals, where the output device 14 may drive one or more speakers using the one or more audio signals using the spatially rendered audio signal. In another aspect, when the piece of audio content is a soundtrack of a motion picture, an audio signal used to drive the speaker 16 may include dialog of the soundtrack and an audio signal used to drive speaker 29 may include background sounds of the soundtrack.

In another aspect, the method performed by the system 10 may include determining whether second electronic device (e.g., playback device 15) satisfies a criterion with respect to playback of at least a second audio signal based on one or more device characteristics of the second electronic device, where the second electronic device may be caused to drive a second speaker of the second device responsive to determining that the second electronic device is adequate. In another aspect, one or more device characteristics may include at least one of a sensitivity, a power rating, and playback availability.

In another aspect, the method may include determining that the first electronic device (e.g., output device 14) is within the threshold distance of a third electronic device within the environment; and determining locations of the second electronic device and the third electronic device within the environment with respect to the first electronic device; and determining which of the second or third electronic devices is to playback the second audio signal based on their respective locations with respect to the first electronic device. In one aspect, determining which of the second or third electronic devices is to playback the second audio device includes comparing one or more device characteristics between the second electronic device and the third electronic device. In some aspects, the first electronic device may be a headset, where the second audio signal includes a spatially rendered audio signal, such that when used to drive the first speaker, a user of the first electronic device may perceive a virtual sound source associated with the second audio signal at a location within the environment, where determining which of the second or third electronic devices is to playback the second audio signal includes determining whether either of the locations of the second electronic device or the third electronic device is at the location within the environment.

In some aspects, the first audio signal may include a first sound and the second audio signal may include a second sound, both sounds may be associated with an XR environment in which a user of the first electronic device is participating. In another aspect, the method may further include: determining a physical location of the second electronic device within the environment with respect to the first electronic device; and determining that the second sound is to originate as a virtual sound source from a virtual location within the XR environment, which corresponds to the physical location of the second electronic device within the environment with respect to the first electronic device, where causing the second electronic device to drive the second speaker includes transmitting a control signal to the second speaker to playback the second sound responsive to determining that the second sound is to originate at the physical location. In one aspect, the virtual sound source may be associated with a virtual object or person at the virtual location within the XR environment.

In one aspect, the first electronic device may be a head mounted device, which may include a display, and the first speaker of the head mounted device may be an extra-aural speaker. In another aspect, the first electronic device may be an open-back headset that may be arranged to allow sound from the environment to pass through the headset to be heard by a user who is wearing the headset. In some aspects, the first electronic device may include a microphone, the device may: capture, using the microphone, a microphone signal that includes sound of the first portion of the audio content played back through the second speaker; and reproduce the sound by applying an acoustic transparency function to the microphone signal.

In one aspect, examples of “hardware” include, but are not limited or restricted to an integrated circuit such as a processor (e.g., a digital signal processor, microprocessor, application specific integrated circuit, a micro-controller, etc.). Thus, different combinations of hardware and/or software can be implemented to perform the processes or functions described by the above terms, as understood by one skilled in the art. Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

Some portions of the preceding detailed descriptions have been presented in terms of algorithms and symbolic representations of operations on data bits within a computer memory. These algorithmic descriptions and representations are the ways used by those skilled in the audio processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined, or removed, performed in parallel or in serial, as necessary, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination hardware devices and software components.

As previously explained, an aspect of the disclosure may be a non-transitory machine-readable medium (such as microelectronic memory) having stored thereon instructions, which program one or more data processing components (generically referred to here as a “processor”) to perform selective audio playback operations, digital signal processing operations, rendering operations, network operations, and/or audio signal processing operations, as described herein. In other aspects, some of these operations might be performed by specific hardware components that contain hardwired logic. Those operations might alternatively be performed by any combination of programmed data processing components and fixed hardwired circuit components.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by at least one programmed processor of a first electronic device, the method comprising:
driving a first speaker of the first electronic device using a mix of a first audio signal and a second audio signal;
determining that the first electronic device is within a threshold distance of a second electronic device within an environment in which the first electronic device is located, the second electronic device comprising a second speaker; and
responsive to the determining that the first electronic device is within the threshold distance,
causing the second electronic device to drive the second speaker with the second audio signal; and
driving the first speaker using the first audio signal instead of the mix.

2. The method of claim 1, wherein the first audio signal and the second audio signal include different portions of a piece of audio content.

3. The method of claim 1, wherein the first audio signal comprises sound of a first software application and the second audio signal comprises sound of a second software application.

4. The method of claim 1 further comprising:
determining, for each of the first and second audio signals, one or more audio characteristics; and
selecting the second audio signal for playback by the second electronic device based on a comparison between the one or more audio characteristics of the first and second audio signals.

5. The method of claim 4, wherein the one or more audio characteristics comprises at least one of: an indication of whether a respective audio signal is of a private or a non-private nature, a spectral analysis of the respective audio signal, a type of audio content associated with the respective audio signal, and spatial characteristics of the audio content associated with the respective audio signal.

6. The method of claim 4, wherein the one or more audio characteristics of the second audio signal comprises an indication that sound of the second audio signal is shared with a third electronic device that is within the environment with the first electronic device, wherein the second audio signal is selected based on the indication.

7. The method of claim 1 further comprising:
capturing, using a microphone of the first electronic device, a microphone signal that includes one or more sounds of the environment that has sound of the second audio signal produced by the second speaker; and
reproducing at least the sound of the second audio signal through the first speaker by applying an acoustic transparency function to the microphone signal.

8. A first electronic device comprising:
a first speaker;
at least one processor; and
memory having stored therein instructions which when executed by the at least one processor causes the first electronic device to:
receive audio content,
determine that the first electronic device is within a physically audible range of a second electronic device, wherein the second electronic device comprises a second speaker,
cause the second electronic device to playback a first portion of the audio content through the second speaker, and
playback a second portion of the audio content through the first speaker.

9. The first electronic device of claim 8, wherein the first portion of the audio content comprises direct sound and the second portion of the audio content comprises ambient sound.

10. The first electronic device of claim 8, wherein the audio content is of an extended reality (XR) environment in which a first user of the first electronic device is participating, wherein the first portion of the audio content comprises speech of a second user who is participating within the XR environment.

11. The first electronic device of claim 10 further comprises a display, wherein the memory has further instructions to:
display a visual representation of the XR environment that includes an avatar of the second user; and
responsive to determining that the first electronic device is within a physically audible range of the second electronic device, move the avatar to a virtual location within the XR environment that corresponds to a physical location of the second electronic device with respect to the first electronic device.

12. The first electronic device of claim 8, wherein the memory has further instructions to decompose the audio content into the first portion and the second portion based on an audio characteristic of the audio content.

13. The first electronic device of claim 12, wherein the audio characteristic comprises an indication of at least one of that 1) the second portion includes speech of an audio call between the first electronic device and another electronic device and an indication that the first portion includes background sounds of the audio call, 2) the first portion includes non-private speech, and 3) the first portion includes sounds shared between the first electronic device and another electronic device.

14. The first electronic device of claim 8, wherein the first electronic device is a head mounted device and the first speaker is an extra-aural speaker.

15. A processor of a headset that is configured to:
playback a first sound and a second sound of audio content through a first speaker;
determine that an electronic device is to playback the first sound of the audio content through a second speaker; and
responsive to determining that the electronic device is to playback the first sound,
transmit, via a wireless connection, a control signal to the electronic device to cause the electronic device to playback the first sound of the audio content through the second speaker;
cease playing back the first sound of the audio content through the first speaker; and
continue to playback the second sound of the audio content through the first speaker.

16. The processor of claim 15 is further configured to determine that the electronic device is within a threshold distance of the headset, wherein a determination that the electronic device is to playback the first sound is in response to determining that the electronic device is within the threshold distance.

17. The processor of claim 16, wherein the electronic device is a first electronic device, wherein the processor is further configured to:
determine that the headset is within the threshold distance from a second electronic device; and
determine, for each of the first and second electronic devices, a device characteristic,
wherein determining that the electronic device is to playback the first sound comprises determining that the first electronic device is to playback the first sound of the audio content instead of the second electronic device based on a comparison of the device characteristics of the first and second electronic devices.

18. The processor of claim 17, wherein the device characteristics of the first and second electronic devices comprises at least one of locations, sensitivities, power ratings and playback availabilities of the first and second electronic devices.

19. The processor of claim 18, wherein determining the device characteristic comprises determining a first physical location of the first electronic device within an environment of the headset and a second physical location of the second electronic device within the environment,
wherein the first sound is associated with a virtual sound source at a virtual location within an extended reality (XR) environment,
wherein determining that the first electronic device is to playback the first sound comprises determining that the virtual location within the XR environment corresponds to the first physical location of the first electronic device within the environment.

20. The processor of claim 16 is further configured to:
determine that the headset is outside the threshold distance from the electronic device; and
responsive to a determination that the headset is outside the threshold distance,
transmit, via the wireless connection, another control signal to the electronic device to cause the electronic device to cease playback of the first sound; and
begin to playback the first and second sounds of the audio content through the first speaker.
